(19) United States
(12) Patent Application Publication
(10) Pub. No.: US 2023/0276855 A1
(43) Pub. Date: Sep. 7, 2023

(54) AEROSOL PROVISION DEVICE

(71) Applicant: Nicoventures Trading Limited, LONDON (GB)

(72) Inventors: Richard HEPWORTH, London (GB); Benjamin TAYLOR, London (GB); Matthew HODGSON, London (GB); Gary FALLON, London (GB)

(21) Appl. No.: 18/040,059

(22) PCT Filed: Jul. 22, 2021
(86) PCT No.: PCT/EP2021/070610

§ 371 Date: Jan. 31, 2023

(30) Foreign Application Priority Data
Jul. 31, 2020 (GB) 2011955.8
Jun. 18, 2021 (GB) 2108771.3

(51) Int. Cl. A24F 40/485; A24F 40/20; A24F 40/465; A24D 1/20; H05B 3/42

(52) U.S. Cl. CPC A24F 40/485; A24F 40/20; A24F 40/465; A24D 1/20; H05B 3/42

(57) ABSTRACT

An aerosol provision device is described. The device generates an aerosol from aerosol-generating material. The device has a receptacle defining a heating zone in which at least a portion of an article including aerosol-generating material is received. A heating element protrudes into the heating zone to heat the heating zone. An air path is defined through the heating element.

### PRIORITY CLAIM

The present application is a National Phase entry of PCT Application No. PCT/EP2021/070610, filed Jul. 22, 2021, which claims priority from GB Application No. 2011955.8, filed Jul. 31, 2020 and GB Application No. 2108771.3, filed Jun. 18, 2021, each of which hereby fully incorporated herein by reference.

### TECHNICAL FIELD

The present disclosure relates to an aerosol provision device for generating an aerosol from aerosol-generating material. The present disclosure also relates to an aerosol provision system comprising an aerosol provision device and an article comprising aerosol-generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

The present application provides an aerosol provision device for generating an aerosol from aerosol-generating material comprising a receptacle defining a heating zone configured to receive at least a portion of an article comprising aerosol-generating material, and a heating element protruding into the heating zone and configured to heat the heating zone, wherein an air path is defined through the heating element.

The heating element may protrude into the heating zone and be configured to be heated to a temperature sufficient to generate aerosol from the aerosol-generating material.

The air path may communicate between external to the heating zone and the heating zone.

An air flow arrangement may form part of an air path. The air flow arrangement may provide at least part of an airflow pathway from a location external to the device and through the heating zone.

The heating element may comprise an air conduit and an air outlet in fluid communication between the air conduit and the heating zone.

The air conduit may extend longitudinally along the heating element.

The heating element may be hollow. The heating element may be tubular.

The heating element may comprise a heating member. The heating member may comprise a peripheral wall. The heating member may comprise a closed end.

The air outlet may comprise an air aperture on an outer side of the heating element.

The air outlet may comprise an array of air apertures. As used herein, the term ‘array of air apertures’ is intended to mean two or more air apertures.

The array of air apertures may be distributed circumferentially around the heating element.

The array of air apertures may be distributed axially along the heating element.

At least a first air aperture of the array of air aperture may differ in flow area from at least a second air aperture of the array of air apertures.

The heating element may protrude from the receptacle into the heating zone at a distal end and has a free end towards a proximal end. The end of the receptacle closest to the opening is the proximal end of the device because, in use, it is closest to the mouth of the user. The other end of the receptacle furthest away from an opening of the receptacle is the distal end of the receptacle because, in use, it is the end furthest away from the mouth of the user.

The flow area of the array of air apertures may increase in a direction from the distal end to the proximal end.

The flow area of the array of air apertures may increase in a direction from the proximal end to the distal end.

The density of air apertures of the array of air apertures may increase in a direction from the distal end to the proximal end. Density in this context means number of or concentration of air apertures per unit area of the heating element.

The density of air apertures of the array of air apertures may decrease in a direction from the distal end to the proximal end. Density in this context means number of or concentration of air apertures per unit area of the heating element.

The device may comprise a first wall region of the heating element comprising the array of air apertures, and a second wall region of the heating element free of the array of air apertures.

The first region may be a band. The second region may be a band.

The air outlet may comprise a mesh. The air outlet may comprise an array of perforations.

The air apertures may be elongate.

The air apertures may extend in a longitudinal direction of the heating element.

The air conduit may be a first air conduit and the air outlet may be a first air outlet, and the heating element may comprise a second air conduit and a second air outlet in fluid communication between the second air conduit and the heating zone.

The first and second air conduits may be fluidly isolated in the heating element.

The device may comprise a seal arranged to seal between the article and at least one of the receptacle and the heating element.

The seal may extend around the heating element.

The seal may comprise at least one of a lip seal, an o-ring, a face seal, a chamfer, a collar, a shoulder, and a protrusion.

The heating element may comprise heating material that is heatable by penetration with a varying magnetic field.

The heating material may define the air path.

The receptacle may be free from heating material that is heatable by penetration with a varying magnetic field.

The device may comprise a magnetic field generator including an inductor coil configured to generate a varying magnetic field.

The inductor coil may be helical. The inductor coil may at least partially encircle the heating zone.

The inductor coil may be a flat coil. The inductor coil may be a spiral coil.

The inductor coil may at least partially extend in the heating element.

The heating element may comprise part of a resistive heating arrangement.

The present application also provides a non-combustible aerosol provision device comprising a receptacle that defines a rod shaped consumable receiving space, a fluid distribution column that upstands from a base of the receptacle and into the rod shaped consumable receiving space so that, in use, a rod shaped consumable may be placed over the distribution column so that the fluid distribution column extends within the rod shaped consumable, and a heater configured to heat the rod shaped consumable receiving space comprising an inductor coil that extends around the receptacle, wherein the fluid distribution column is configured to be inductively heated by the inductor coil.

The fluid distribution column may comprise a heating element comprising heating material that is eatable by penetration with a varying magnetic field.

The rod shaped consumable receiving space may comprise a heating zone.

The present application also provides an aerosol provision system comprising the aerosol provision device of any of the above, and an article comprising aerosol generating material.

The present application also provides an aerosol-provision system comprising an article comprising aerosol-generating material, an aerosol provision device for heating aerosol-generating material comprising a receptacle defining a heating zone configured to receive at least a portion of an article comprising aerosol-generating material, and a heating element protruding in the heating zone and configured to heat the heating zone, wherein an air path is defined through the heating element.

The article may comprise a pre-formed bore configured to receive the heating element.

The article may be a consumable.

The heating element may be removable from the heating zone. The heating element may be interchangeable.

The heating element may upstand from the base. The heating element may comprise a sharp edge or point at a free end. The heating element may be a pin or blade. The heating element may be configured to pierce the article received by the heating zone.

The heating element and receptacle may be co-axial.

The apparatus of this aspect can include one or more, or all, of the features described above, as appropriate.

The aerosol generating device may be a non-combustible aerosol generating device.

The device may be a tobacco heating device, also known as a heat-not-burn device.

The aerosol generating material may be non-liquid aerosol generating material.

The article may be dimensioned to be at least partially received within the heating zone.

According to an aspect, there is provided an aerosol generating device for generating an aerosol from aerosol-generating material comprising: a receptacle defining a heating zone configured to receive at least a portion of an article comprising aerosol-generating material, and a heating element arranged to heat the heating zone.

According to an aspect, there is provided an aerosol-generating system comprising an article comprising aerosol-generating material; an aerosol generating device for heating aerosol-generating material comprising a heating zone configured to receive at least a portion of the article; and a heating element.

The apparatus of these aspects can include one or more, or all, of the features described above, as appropriate.

### BRIEF DESCRIPTION OF THE DRAWINGS

Embodiments will now be described, by way of example only, and with reference to the accompanying drawings in which:

FIG. 1 shows a front perspective view of an aerosol provision system with an aerosol provision device and an article inserted into the device.

FIG. 2 shows schematically the aerosol provision system of FIG. 1.

FIG. 3 shows schematically part of the aerosol provision system of FIG. 1 with the article partially withdrawn from the device.

FIG. 4 shows schematically part of another arrangement of the aerosol provision system of FIG. 1 with the article partially withdrawn from the device.

FIG. 5 shows a schematic cross-section of a heating element of the aerosol provision system of FIG. 1.

FIG. 6 shows another schematic cross-section of a heating element of the aerosol provision system of FIG. 1.

FIG. 7 shows another schematic cross-section of a heating element of the aerosol provision system of FIG. 1.

FIG. 8 shows another schematic cross-section of a heating element of the aerosol provision system of FIG. 1.

FIG. 9 shows another schematic cross-section of a heating element of the aerosol provision system of FIG. 1.

FIG. 10 shows another schematic cross-section of a heating element of the aerosol provision system of FIG. 1.

FIG. 11 shows another schematic cross-section of a heating element of the aerosol provision system of FIG. 1.

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavorants. Aerosol-generating material may include any plant based material, such as tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine. Aerosol-generating material may for example be in the form of a solid, a liquid, a gel, a wax or the like. Aerosol-generating material may for example also be a combination or a blend of materials. Aerosol-generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt % or 70 wt % of amorphous solid, to about 90 wt %, 95 wt % or 100 wt % of amorphous solid.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

Apparatus is known that heats aerosol generating material to volatilize at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporize an aerosol generating material in the form of a liquid, which may or may not contain nicotine. The aerosol generating material may be in the form of or be provided as part of a rod, cartridge or cassette or the like which can be inserted into the apparatus. A heater for heating and volatilizing the aerosol generating material may be provided as a “permanent” part of the apparatus.

An aerosol generating device can receive an article comprising aerosol generating material for heating. An “article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

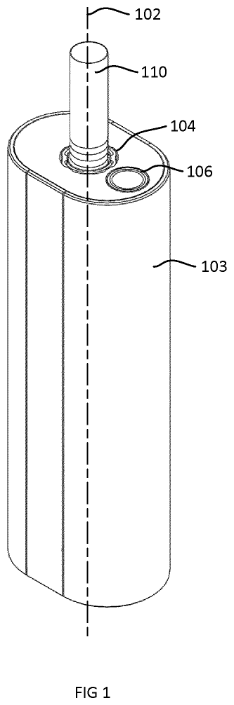

FIG. 1 shows an example of an aerosol provision system 100. The system 100 comprises an aerosol provision device 101 for generating aerosol from an aerosol generating medium/material, and a replaceable article 110 comprising the aerosol generating medium. The device 101 is a non-combustible aerosol provision device. The device 101 can be used to heat the replaceable article 110 comprising the aerosol generating medium, to generate an aerosol or other inhalable medium which can be inhaled by a user of the device 101.

The device 101 comprises a housing 103 which surrounds and houses various components of the device 101. The housing 103 is elongate. The device 101 has an opening 104 in one end, through which the article 110 can be inserted for heating by the device 101. The article 110 may be fully or partially inserted into the device 101 for heating by the device 101.

The device 101 may comprise a user-operable control element 106, such as a button or switch, which operates the device 101 when operated, e.g. pressed. For example, a user may activate the device 101 by pressing the switch 106.

The device 101 defines a longitudinal axis 102, along which an article 110 may extend when inserted into the device 101. The opening 104 is aligned on the longitudinal axis 102.

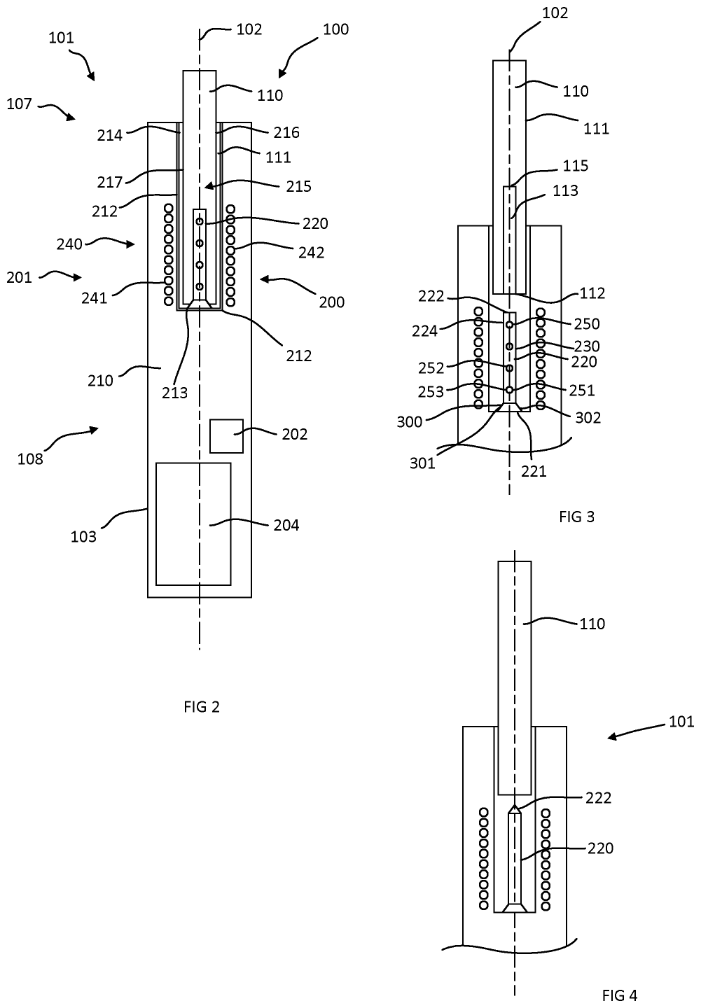

FIG. 2 is a schematic illustration of the aerosol provision system 100 of FIG. 1, showing various components of the device 101. It will be appreciated that the device 101 may include other components not shown in FIG. 2.

As shown in FIG. 2, the device 101 includes an apparatus for heating aerosol generating material 200. The apparatus 200 includes a heating assembly 201, a controller (control circuit) 202, and a power source 204. The apparatus 200 comprises a body assembly 210. The body assembly 210 may include a chassis and other components forming part of the device. The heating assembly 201 is configured to heat the aerosol-generating medium or material of an article 110 inserted into the device 101, such that an aerosol is generated from the aerosol generating medium. The power source 204 supplies electrical power to the heating assembly 201, and the heating assembly 201 converts the supplied electrical energy into heat energy for heating the aerosol-generating material.

The power source 204 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery.

The power source 204 may be electrically coupled to the heating assembly 201 to supply electrical power when required and under control of the controller 202 to heat the aerosol generating material. The control circuit 202 may be configured to activate and deactivate the heating assembly 201 based on a user operating the control element 106. For example, the controller 202 may activate the heating assembly 201 in response to a user operating the switch 106.

The end of the device 101 closest to the opening 104 may be known as the proximal end (or mouth end) 107 of the device 101 because, in use, it is closest to the mouth of the user. In use, a user inserts an article 110 into the opening 104, operates the user control 106 to begin heating the aerosol generating material and draws on the aerosol generated in the device. This causes the aerosol to flow through the article 110 along a flow path towards the proximal end of the device 101.

The other end of the device furthest away from the opening 104 may be known as the distal end 108 of the device 101 because, in use, it is the end furthest away from the mouth of the user. As a user draws on the aerosol generated in the device, the aerosol flows in a direction towards the proximal end of the device 101. The terms proximal and distal as applied to features of the device 101 will be described by reference to the relative positioning of such features with respect to each other in a proximal-distal direction along the axis 102.

The heating assembly 201 may comprise various components to heat the aerosol generating material of the article 110 via an inductive heating process. Induction heating is a process of heating an electrically conducting heating element (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating element) suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive element and the susceptor, allowing for enhanced freedom in construction and application.

The apparatus 200 includes a heating chamber 211 configured and dimensioned to receive the article 110 to be heated. The heating chamber 211 defines a heating zone 215. In the present example, the article 110 is generally cylindrical, and the heating chamber 211 is correspondingly generally cylindrical in shape. For example, the heating chamber 211 in embodiments is a cylinder having a circular cross section, or an elliptic cylinder, a hyperbolic cylinder or a parabolic cylinder. However, other shapes would be possible for receiving correspondingly shaped articles. The heating chamber 211 is formed by a receptacle 212. The receptacle 212 includes an end wall 213 and a peripheral wall 214. The end wall 213 acts as a base of the receptacle 212. The receptacle 212 in embodiments is a one-piece component. In other embodiments the receptacle 212 comprises two or more components. In embodiments, the receptacle defines a rod shaped consumable receiving space.

The heating chamber 211 is defined by the inner surfaces of the receptacle 212. The receptacle 212 acts as a support member. The receptacle 212 comprises a generally tubular member. The receptacle 212 extends along and around and substantially coaxial with the longitudinal axis 102 of the device 101. However, other shapes would be possible. The receptacle 212 (and so heating zone 215) is open at its proximal end such that an article 110 inserted into the opening 104 of the device 101 can be received by the heating chamber 211 therethrough. The receptacle 212 is closed at its distal end by the end wall 213. The device 101 may comprise one or more air conduits 251 that form part of an air path as described in detail below. In use, the article 110 overlaps the air conduits 251. Air may pass through the one or more conduits forming part of the air path, into the article 110, and flow through the article 110 towards the proximal end of the device 101.

The receptacle 212 is formed free of material that is heatable by penetration with a varying magnetic field. The receptacle 212 may be formed from an insulating material. For example, the receptacle 212 may be formed from a plastic, such as polyether ether ketone (PEEK). Other suitable materials are possible. The receptacle 212 may be formed from such materials ensure that the assembly remains rigid/solid when the heating assembly 201 is operated. Using a non-metallic material for the receptacle 212 may assist with restricting heating of other components of the device 101. The receptacle 212 may be formed from a rigid material to aid support of other components.

Other arrangements for the receptacle 212 would be possible. For example, in an embodiment the end wall 213 is defined by part of the heating assembly 201. In embodiments, the receptacle 212 comprises material that is heatable by penetration with a varying magnetic field.

As illustrated in FIG. 2, the heating assembly 201 comprises a heating element 220. The heating assembly 201 acts as a heater. The heating element 220 is configured to heat the heating zone 215. The heating zone 215 is defined in the heating chamber 211. In embodiments the heating chamber 211 defines a portion of the heating zone 215 or the extent of the heating zone 215.

The heating element 220 is heatable to heat the heating zone 215. The heating element 220 is an induction heating element. That is, the heating element 220 comprises a susceptor that is heatable by penetration with a varying magnetic field. The susceptor comprises electrically conducting material suitable for heating by electromagnetic induction. For example, the susceptor may be formed from a carbon steel. It will be understood that other suitable materials may be used, for example a ferromagnetic material such as iron, nickel or cobalt.

The heating assembly 201 comprises a magnetic field generator 240. The magnetic field generator 240 is configured to generate one or more varying magnetic fields that penetrate the susceptor so as to cause heating in the susceptor. The magnetic field generator 240 includes an inductor coil arrangement 241. The inductor coil arrangement 241 comprises an inductor coil 242, acting as an inductor element. The inductor coil 242 is a helical coil, however other arrangements are envisaged such as a spiral coil. In embodiments, the inductor coil arrangement 241 comprises two or more inductor coils 242. The two or more inductor coils in embodiments are disposed adjacent to each other and may be aligned co-axially along the axis.

In some examples, in use, the inductor coil is configured to heat the heating element 220 to a temperature of between about 200° C. and about 350° C., such as between about 240° C. and about 300° C., or between about 250° C. and about 280° C.

The heating element 220 extends in the heating zone 215. The heating element 220, acting as a protruding element, protrudes in the heating zone 215. The heating element 220 upstands from the base. The heating element 220 is spaced from the peripheral wall 214. The heating assembly 201 is configured such that when an article 110 is received by the heating chamber 211, the heating portion 221 of the heating element 220 extends into a distal end of the article 110. The heating element 220 is positioned, in use, within the article 110. The heating element 220 is configured to heat aerosol generating material of an article 110 from within, and for this reason is referred to as an inner heating element.

The heating element 220 extends into the heating chamber 211 from the distal end of the heating chamber 211 along the longitudinal axis 102 of the device (in the axial direction). In embodiments the heating element 220 extends into the heating chamber 211 spaced from the axis 102. The heating element 220 may be off-axis or non-parallel to the axis 102. Although one heating element 220 is shown, it will be understood that in embodiments, the heating assembly 201 comprises a plurality of heating elements 220. Such heating elements in embodiments are spaced from but parallel to each other.

The inductor coil 241 is disposed external to the receptacle 212. The inductor coil 241 encircles the heating zone 215. The helical inductor coil 241 extends around at least a portion of the heating element 220, acting as a susceptor. The helical inductor coil 241 is configured to generate a varying magnetic field that penetrates the heating element 220. The helical inductor coil 241 is arranged coaxially with the heating chamber 211 and longitudinal axis 101. In embodiments, the or one coil is at the distal end of the receptacle 212. The coil, for example, is a flat spiral coil.

The inductor coil 241 is a helical coil comprising electrically-conductive material, such as copper. The coil is formed from wire, such as Litz wire, which is wound helically around a support member (not shown). The support member is formed by the receptacle 212 or by another component. In embodiments, the support member is omitted. The support member is tubular. The coil 241 defines a generally tubular shape. The inductor coil 241 has a generally circular profile. In other embodiments, the inductor coil 241 may have a different shape, such as generally square, rectangular or elliptical. The coil width may increase or decrease along its length.

Other types of inductor coil may be used, for example a flat spiral coil. With a helical coil it is possible to define an elongate inductor zone in which to receive a susceptor, which provides an elongate length of susceptor to be received in the elongate inductor zone. The length of susceptor subjected to varying magnetic field may be maximized By providing an enclosed inductor zone with a helical coil arrangement it is possible to aid the flux concentration of the magnetic field.

Litz wire comprises a plurality of individual wires which are individually insulated and are twisted together to form a single wire. Litz wires are designed to reduce the skin effect losses in a conductor. Other wire types could be used, such as solid. The configuration of the helical inductor coil may vary along its axial length. For example, the inductor coil, or each inductor coil, may have substantially the same or different values of inductance, axial lengths, radii, pitches, numbers of turns, etc.

The heating element 220 protrudes in the heating zone 215 and is received by the article 110. FIG. 2 shows the article 110 received in the device 101. The article 110 is sized to be received by the receptacle 212. The outer dimensions of the article 110 perpendicular to the longitudinal axis of the article 110 substantially correspond with the inner dimensions of the chamber 211 perpendicular to the longitudinal axis 102 of the device 101 to allow insertion of the article 110 into the receptacle 212. In embodiments, a gap 216 is defined between an outer side 111 of the article 110 and an inner side 217 of the receptacle 212. The gap 216 may act as an air passage along at least part of the axial length of the chamber 211. An insertion end 112 of the article 110 is arranged to lie adjacent to the base of the receptacle 212.

FIG. 3 shows the article 110 partially inserted into the device 101. As shown, the article 110 is spaced from the heating element 220 in the heating zone 215. The article 110 may be in the process of being inserted or withdrawn from the heating zone 215.

The heating element 220 extends in the heating zone 215 from the distal end of the receptacle 212. The heating element 220 upstands from the end wall 213. The heating element 220 comprises a heating member 224. The heating member 224 is elongate. The heating element 220 comprises a base end 221 and an opposing free end 222. The heating portion 221 is a pin or column. Other shapes are envisaged, for example the heating portion 221 in embodiments is a blade.

The heating element 220 comprises an outer surface 223. The outer surface 223 extends around the heating element 220. The outer surface 223 extends between the base end 221 and the free end 222. The heating element 220 is generally cylindrical although other shapes are envisaged. For example, the heating element 220 in embodiments is a cylinder having a circular cross section, or an elliptic cylinder, a hyperbolic cylinder or a parabolic cylinder. Other profile shapes include square, rectangular, cross-shaped, etc. Other cross sectional shapes, configured to be used with articles having a corresponding article bore, are anticipated. The outer surface 223 defines an outer side of the heating element 220. In embodiments, the heating element is tapered. The heating element may comprise one or more tapered portions. The heating element may taper towards the free end.

The article 110, in embodiments, is a rod shaped consumable. The article 110 comprises a bore 113. The bore 113 is pre-formed in the article 110. The bore 113 is formed in embodiments by a tubular portion of the article 110. The bore 113 in embodiments extends partially along the longitudinal axis of the article. The bore 113 comprises an inner surface 114. The bore 113 has a closed end 115. The heating member 224 is sized to be received in the bore 113. The heating member 224 and bore 113 are complimentary sized to form a slide fit. The inner surface 114 of the bore is configured to form a close contact with the heating member 224 to maximize heat transfer between the heating element 220 and the article 110.

The heating element 220 comprises a seal 300. The seal 300 is arranged to seal with the article 110 in the heating chamber 211. The seal 300 seals around the heating member 224. The seal 300 may form part of the receptacle 212. The seal 300 forms a sealing action between the article 110 and the heating element 220. The seal 300 acts to isolate an airflow path through the article from outside the article. The seal comprises a sealing face 301. The seal 300 comprises a chamfer 302. Other configurations such as a face seal, lip seal, step and O-ring are anticipated.

The free end 222 in the present embodiment is blunt. Referring to FIG. 4, in embodiments, the bore 113 in the article 110 is omitted. In embodiments the outer dimensions of the heating element are greater than those of the bore. In such arrangements, the heating element is configured to deform and/or distend the article 110 to be inserted into the article 110. To facilitate this, the inner heating element 220 is configured to pierce an article 110 that is inserted into the device 101. In such an embodiment, the free end 222 of the heating element 220 comprises a sharp edge or point. The free end 222 of the heating element 220 in embodiments comprises a sharp edge, point or other guide feature to aid location of the heating element 220 in the article 110.

An air flow arrangement 250 is provided. The air flow arrangement 250 forms part of an air path through the heating zone 215. This air flow arrangement 250 provides an airflow path such that when the device is in use, when the user inhales, air flows from a location external to the device and through the heating zone 215, thereby allowing the user to inhale the aerosol in the heating zone 215 which has been produced by the aerosol-generating material.

The air flow arrangement 250 defines part of the air path along which air may pass into the heating chamber 211. The air flows through the article in the heating chamber 211 towards the proximal end of the device 101. The air flow arrangement 250 comprises the air conduit 251 in the heating element 220. In an embodiment, at least one further air conduit is located in the end wall 213 (not shown). The air conduit 251 communicates external to the receptacle 212 with the heating chamber 211.

An air outlet 252 is formed in the heating element 220. The heating element 220 acts as a fluid distribution column. The heating element 220, acting as a fluid distribution column, upstands from the end wall 213. The article 110 may be placed over the distribution column so that the heating element 220, acting as the distribution column, extends within the article. The distribution column is configured to be inductively heated by the inductor coil. The air outlet 252 comprises an array of apertures 253 in the outer surface 223 of the heating element 220. The number of apertures 253 may vary, and may comprise a single aperture. In the embodiment in FIG. 3, the heating element 220 is tubular with the array of apertures 253 communicating between an inner side and an outer side of the heating element 220. The configuration and arrangement of the air flow arrangement 250, for example the array of apertures, may differ in embodiments. Although four apertures 253 are shown, the array of apertures 253 in embodiments is two or more apertures. In some embodiments, the air outlet 252 comprises a single air aperture.

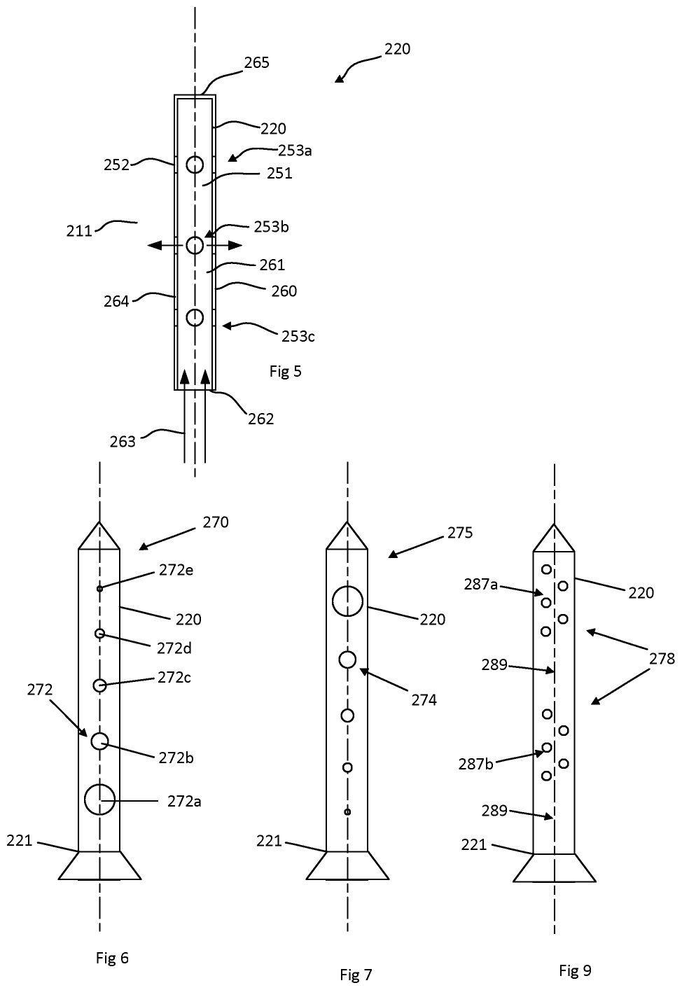

FIGS. 5 to 8 illustrate embodiments of heating elements 220 suitable for providing an air path as described above. The heating elements 220 are shown in isolation of other features of the device 101.

Referring to FIG. 5, one arrangement of the heating element 220 is shown. The heating element 220 is hollow. The heating element 220 comprises a body 260. The body 260 is formed by the heating member 224. The heating member 224 defines a bore 261. The bore 261 extends longitudinally along the heating member 224 from the distal end towards the proximal end. The bore 261 defines the air conduit 251.

The heating element 220 has an air inlet 262. Air is supplied to the air conduit 251 through the air inlet 262. Air flow into the heating element 220 is defined by arrows 263. The air inlet 262 provides an air path from a location external to the receptacle 212, through the heating element 220, and out of the air outlet 252 in the heating element 220 into the heating chamber 211. Air may pass through a passage (not shown) formed in the body assembly 210 of the device, from outside of the body assembly 210, to fluidly communicate with the air conduit 251 thereby providing air to the air conduit 251. In some embodiments, two or more air conduits are provided in the heating element 220. In such an embodiment, two separate passages may be defined in the heating element 220. Each air conduit has one or more separate air inlets and one or more separate air outlets. As such, different air flow characteristics may be supplied at different regions of the heating element and therefore to different parts of the article. Each of the plurality of conduits may be fluidly isolated from one another in the heating element 220.

The heating element 220 comprises a side wall 264 and an end wall 265. The end wall 265 forms a closed end of the air conduit 251. It will be understood that the air conduit 251 is formed by a cavity, such as a bore or passage, in the heating member 224. As such, the air conduit 251 may extend only part way along the length of the heating member 224.

The heating member 224 is formed from a heating material which is heatable by penetration with a varying magnetic field. As such, the heating member 224 acts as a susceptor. The entire heating member 224 may be formed from the heating material, such that the conduit and air outlet are formed by the material. In embodiments the heating member 224 comprises a support and a layer of heating material, such that the conduit and/or air outlet is formed by the support.

The air outlet 252 comprises the array of apertures 253. Each aperture 253 extends through the heating member 224 from an inner side to an outer side. The apertures 253 are formed through the side wall of the heating member 224.

As shown in FIG. 5, the apertures 252 illustrated are circular. In some embodiments, the apertures have different shapes. For example tear-shaped apertures may be provided. Such a shape may help to direct the airflow out of the air outlet 252 in a particular direction. A central axis of the apertures 253 may be angled relative a direction normal to an outer surface of the heating element 220. This may also help to direct the airflow out of the apertures in a particular direction.

In embodiments, the size and location of the apertures 253 is selected to provide different airflow configurations. For example, different airflow may be provided to different portions of the heating chamber 211. The apertures 253 can be selected to provide a particular inhalation experience for the user. For example, the configuration of the apertures may affect the resistance to inhalation that the device provides. Particular patterns or arrangements of the apertures will provide different sensations to the user when they inhale, which may be desirable to enhance the user experience of the device. It may also be advantageous to have a higher density or total area of apertures 253 per unit area in particular locations of the heating chamber 211, so that particular portions of the aerosol-generating material are induced to produce aerosol before other portions of the aerosol-generating material. This may affect, for example, delivery of aerosol from the aerosol-generating material in use and thus may provide longer-lasting aerosol generation, or a more intense delivery of aerosol. The aerosol-generating material may also be designed to vary in consistency or material properties, for example may comprise different sections made up of different material, and the configuration of the apertures 253 may be provided to cater for the different material properties in different sections as appropriate.

There are three sets of apertures 253a, 253b, 253c in the heating element 220. Each set of apertures 253a, 253b, 253c is arranged as a circumferential band of apertures. The number of sets may vary and may be more or fewer than three sets, for example FIGS. 2 and 3 show four sets. The sets of apertures 253a, 253b, 253c are spaced along the length of the heating element 220. The sets 253a, 253b, 253c are equally spaced apart along the length of the heating element 220. In embodiments, the spacing may vary. Each set of apertures includes a plurality of the air apertures 253. The apertures in each set 253a, 253b, 253c are distributed equidistant relative to one another about the circumference of the heating element 220. Again, the circumferential spacing of the apertures 253 may vary.

In the example shown in FIG. 5, there are four apertures within each set 253a, 253b, 253c of apertures 253, but there may be more or fewer than four apertures within each set 253a, 253b, 253c. This arrangement of apertures 253 may help to provide evenly distributed airflow to each region of the aerosol-generating material along the heating element 220. This may help to ensure that all of the aerosol-generating material receives airflow, and therefore that the aerosol generating material produces the aerosol as quickly as possible after the heating element 220 heats up. This may also ensure that all of the aerosol-generating material is used up during use. An even distribution of airflow to the heating chamber 211 may also enhance the user experience and may also help avoid saturation of the aerosol generated within the heating chamber 211, and thus may increase the efficiency of the device.

The heating element 220 illustrated in FIG. 5 is generally cylindrically shaped with a truncated end. One or more apertures may be formed in the truncated end of the heating element 220. This may have the advantage of providing airflow to a region of the heating chamber 221 beyond the end of the heating element 220. The heating element 220 in embodiments has a cone-shaped end portion (such as those illustrated in FIGS. 6 to 9), and similarly apertures may be formed in the cone-shaped portion. It would be understood that alternatively shaped end portions (not shown) may also be provided. Furthermore, as mentioned previously, in embodiments the heating element 220 is not be generally cylindrical and may have a different shape, for example a blade shape.

FIG. 6 illustrates another arrangement of the heating element 220. The configuration of the heating element 220 in FIG. 6 is generally the same as that described above with reference to FIG. 5, and so a detailed description will be omitted. However, in FIG. 6 the configuration of an air flow arrangement 270 differs. In particular, the configuration of an array of apertures 272 differs.

The heating element 220 has an air outlet 271 comprising the array of apertures 272. The array of apertures 272 have a linear arrangement in a direction along the length of the heating element 220. The flow area of the apertures 272 decreases in a direction from the distal end to the proximal end. In the present embodiment, the diameter of each hole forming an aperture varies. The diameter of adjacent holes decreases in a direction from the distal end to the proximal end. A distal aperture 272a nearest to the base end 221 of the heating element 220 has a greater flow area than an adjacent proximal aperture 272b. Such a change in flow area of apertures 272a, 272b, 272c, 272d, 272e continues in the axial direction such that the aperture 272e nearest to the opposing free end 222 of the heating element 220 defines the smallest flow area of the array of apertures 272. In this embodiment, the apertures 272 decrease in flow area sequentially or progressively, in a direction from the distal end to the proximal end. When the apertures 272 have a circular cross-section, as shown in FIG. 6, the decrease in flow area means that a diameter of a cross section of the apertures 272 decreases. However, in embodiments the apertures have different cross-sectional shapes.

In other embodiments, the apertures 272 comprise a plurality of groups of apertures with each aperture in the group having the same flow area within each group. For example, in one embodiment six apertures are provided in each linear arrangement, where two apertures closer to the base end 221 have a smaller flow area than two apertures closer to the opposing free end 222, and a mid group of two apertures between the free end 222 and the base end 221 may have a flow area larger than the apertures closer to the free end 222 and smaller than the apertures closer to the base end 221. Different numbers of apertures and groups of apertures may be provided.

The air outlet 271 comprises multiple sets of apertures 272 in linear arrangements, with the sets spaced equidistantly relative to one another about the circumference of the heating element 220. The air outlet 271 also in embodiments comprises apertures which are not in a linear arrangement as shown but which nonetheless provide a greater total aperture area nearer to the base end 221 than the free end 221. For example, in embodiments the air outlet 252 comprises a greater density of apertures proximal to the base end 221 than the free end 222 and additionally or alternatively may comprise larger apertures nearer the base end 221 such that there is a greater area of apertures per unit area of the heating element 220 nearer to the base end 221 compared with the free end 222.

Arrangements with smaller flow area and/or a lower density of apertures 272 in the heating element 220 proximal to the free end 222 (such as that illustrated in FIG. 6) may provide more even airflow to different portions of the heating chamber 211. This may be because the airflow may be more likely to escape through apertures 272 nearer the free end 222 since the airflow may travel through the length of the conduit in the heating element 220, impinge on a closed end of the heating element 220, reduce in velocity and escape through the apertures nearer the free end 222. Having a smaller total flow area of apertures near the free end 222 (and/or apertures which each have a smaller flow area) may therefore rebalance this effect, since the greater total area of apertures nearer the base end 221 (and/or apertures which each have a larger flow area) of the heating element 220 will make it easier for the air to flow out of that region. This may help to provide a consistent air flow volume along the length of the heating element 220, for example keeping the total volume per second of airflow to each region of the heating chamber 211 more even.

FIG. 7 illustrates another arrangement of the heating element 220. The configuration of the heating element 220 in FIG. 7 is generally the same as that described above with reference to FIG. 6, and so a detailed description will be omitted. The main difference between the embodiment in FIG. 7 compared with the embodiment in FIG. 6 is that in the embodiment in FIG. 7 the configuration of an air flow arrangement 275 differs. In particular, the apertures 274 sequentially increase rather than decrease in flow area in a direction from the distal end to the proximal end.

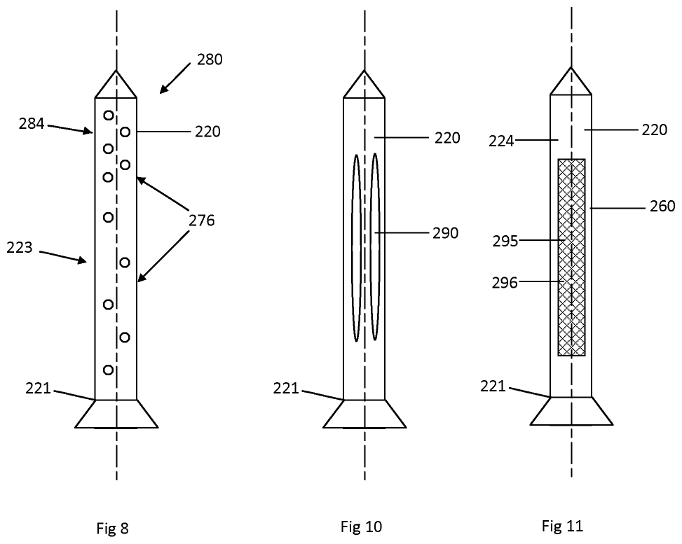

FIG. 8 illustrates another arrangement of the heating element 220. The configuration of the heating element 220 in FIG. 8 is generally the same as that described above with reference to FIG. 5, and so a detailed description will be omitted. However, in FIG. 8 the configuration of an air flow arrangement 280 differs. In particular, the configuration of an array of apertures 276 differs.

The apertures of the array of apertures 276 each have the same flow area. In embodiments, the flow areas may differ. The apertures 283 are arranged along the length of the heating element 220. The apertures 276 are arranged to be arranged closer together in a proximal region 284 towards the free end 222 of the heating element 220. That is, there is a higher density of apertures 276 in the proximal region 284 region. The apertures 276 are arranged further apart in a distal region 285 towards the base end 221. That is, there is a lower density of apertures 276 nearer the base end 221 of the heating element 220. By providing a higher density of apertures in one area, such as towards the free end 222, it is possible to change the sensorial experience by allowing further airflow through a proximal portion of aerosol-generating material. In embodiments, the article comprises sections of different aerosol-generating material and so such an arrangement may aid the air flow to be tailored for the properties of each section.

It will be understood that the flow area and/or density of the array of apertures may vary along the length of the heating element 220. The flow area and/or density of the array of apertures may vary in a circumferential direction around the heating element 220. For example, with a cylindrical heating element 220 the size of apertures may vary circumferentially around the device. The flow area and/or density of the array of apertures may progressively vary along the length of the heating element 220. The flow area and/or density of the array of apertures may progressively vary in a circumferential direction around the heating element 220.

Arrangements with apertures having a greater flow area and/or a greater density of apertures in the heating element 220 towards the free end 222 of the heating element (such as those illustrated in FIGS. 7 and 8) may be combined with at least one air conduit located in the end wall 213 of the receptacle 212, such that the airflow is provided to the distal end of the receptacle 212 from both the conduits in the end wall 213 and the apertures near the base end 221 of the heating element, and airflow is provided nearer the proximal end of the receptacle from the apertures near the free end 222 of the heating element. It may be advantageous to have a greater total flow area of apertures proximal to the free end 222 (and/or apertures which each have a larger flow area) since in such an arrangement the region of the receptacle nearest to the base end 221 of the heating element 220 receives airflow from both the apertures in the heating element 220 and the end wall 213. Therefore, a greater total area of apertures per unit area of the heating element 220 may be desirable to achieve an even distribution of airflow to each region of the heating chamber 211.

Providing a heating element 220 with apertures which vary in size along the length of the heating element 220, such as those shown in FIGS. 6 and 7, and/or arrangements with higher or lower densities of apertures nearest to the base end 221 or free end 222 of the heating element 220 (for example FIG. 8), may allow the device 101 to provide different amounts of airflow to different portions of the aerosol-generating material of the article 110 in dependence on how close the aerosol-generating material is to the distal end of the receptacle 212.

FIG. 9 illustrates another embodiment of a heating element 220. The configuration of the heating element 220 in FIG. 9 is generally the same as that described above with reference to FIG. 5, and so a detailed description will be omitted. However, in FIG. 9 the configuration of an air flow arrangement differs. In particular, the configuration of an array of apertures 278 differs.

The embodiment in FIG. 9 has two regions of apertures, a first region 287a and a second region 287b. The first region 287a is arranged as a first band of apertures and the second region 287b is arranged as a second band of apertures. The first and second regions 287a, 287b are spaced in an axial direction along the heating element. The first band is disposed relatively proximal compared with the first band. Each group of apertures 278 includes a plurality of apertures around the heating element (with some not apparent in the figure). The apertures 278 in each band are substantially evenly distributed. The number of regions of apertures may vary. The heating element 220 comprises two aperture-free regions 289. The number of aperture-free regions may vary, and may comprise a single aperture free region. Creating a space between apertures or groups of apertures may allow for a zonal effect on aerosol-generating material, with the aerosol-generating material in sections being heated slightly more intensely than other sections.

By providing at least one aperture free region it is possible to aid control of airflow into the article. In embodiments it is also possible to concentrate the flow of air into discrete areas of the article. The or each aperture-free region is non-permeable.

As shown in FIG. 10, the heating element 220 includes an air flow arrangement having has elongate apertures 290. As shown, the apertures 290 are oval, however other shapes are anticipated. Elongate apertures may aid with minimizing the number of apertures whilst maximizing a flow area through the air outlet 252. Furthermore, the heating element 220 in embodiments comprises a plurality of different configurations of apertures.

Although the heating elements 220 described with reference to FIGS. 5 to 10 comprise open apertures, it will be understood that the heating element 220 in embodiments comprises a barrier to restrict the ingress of debris or detritus into the air conduit 251. The apertures may be of a sufficient size to acceptably restrict the ingress of detritus into the heating element 220. In embodiments, the apertures have a diameter range of 0.5 mm to 1 mm. As shown in FIG. 11, the heating element may comprise an air flow arrangement having an air aperture 295 with a mesh 296. The mesh 296 extends over the air aperture 295. The mesh 296 defines a plurality of openings or perforations to allow fluid passage. The mesh 296 in embodiments is formed from a susceptor material. In such an arrangement the mesh 296 acts to heat the heating zone 215 either together with or alternatively to the body 260 of the heating element 220. In other embodiments, the mesh 296 is free of heating material. In embodiments, an array of perforations are formed through the body to act as the air apertures.

The heating element 220 is configured to heat aerosol generating material of an article 110 sufficiently to generate aerosol from the aerosol-generating material, without requiring heating from another source.

In the above described embodiments, the heating arrangement is an inductive heating arrangement. In embodiments, other types of heating arrangement are used, such as resistive heating. The configuration of the device is generally as described above and so a detailed description will be omitted. In such arrangements the heating assembly 201 comprises a resistive heating generator including components to heat the heating element via a resistive heating process. In this case, an electrical current is directly applied to a resistive heating component, and the resulting flow of current in the heating component causes the heating component to be heated by Joule heating. The resistive heating component comprises resistive material configured to generate heat when a suitable electrical current passes through it, and the heating assembly comprises electrical contacts for supplying electrical current to the resistive material.

In embodiments, the heating element forms the resistive heating component itself. In embodiments the resistive heating component transfers heat to the heating element, for example by conduction.

The above embodiments are to be understood as illustrative examples of the disclosure. Further embodiments of the disclosure are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An aerosol provision device for generating an aerosol from aerosol-generating material comprising:
a receptacle defining a heating zone configured to receive at least a portion of an article comprising aerosol-generating material; and
a heating element protruding into the heating zone and configured to heat the heating zone, wherein an air path is defined through the heating element.

2. The aerosol provision device of claim 1, wherein the heating element protruding into the heating zone is configured to be heated to a temperature sufficient to generate aerosol from the aerosol-generating material.

3. The aerosol provision device of claim 1, wherein the air path communicates between external to the heating zone and the heating zone.

4. The aerosol provision device of claim 1, wherein the heating element comprises an air conduit and an air outlet in fluid communication between the air conduit and the heating zone.

5. (canceled)

6. (canceled)

7. The aerosol provision device of claim 4, wherein the air outlet comprises an air aperture on an outer side of the heating element.

8. The aerosol provision device of claim 7, wherein the air outlet comprises an array of air apertures.

9. (canceled)

10. (canceled)

11. The aerosol provision device of claim 8, wherein at least a first air aperture of the array of air aperture differs in flow area from at least a second air aperture of the array of air apertures.

12. The aerosol provision device of claim 8, wherein the heating element protrudes from the receptacle into the heating zone at a distal end of the receptacle and has a free end towards a proximal end of the receptacle.

13. The aerosol provision device of claim 12, wherein a flow area of the array of air apertures increases in a direction from the distal end to the proximal end.

14. The aerosol provision device of claim 12, wherein a flow area of the array of air apertures increases in a direction from the proximal end to the distal end.

15. The aerosol provision device of claim 12, wherein a density of air apertures of the array of air apertures increases in a direction from the distal end to the proximal end.

16. The aerosol provision device of claim 12, wherein a density of air apertures of the array of air apertures decreases in a direction from the distal end to the proximal end.

17. The aerosol provision device of claim 8, comprising a first wall region of the heating element comprising the array of air apertures, and a second wall region of the heating element free of the array of air apertures.

18. The aerosol provision device of claim 4, wherein the air outlet comprises a mesh.

19. The aerosol provision device of claim 4, wherein the air conduit is a first air conduit and the air outlet is a first air outlet, and the heating element comprises a second air conduit and a second air outlet in fluid communication between the second air conduit and the heating zone.

20. (canceled)

21. (canceled)

22. The aerosol provision device of claim 1, wherein the heating element comprises heating material that is heatable by penetration with a varying magnetic field.

23-26. (Canceled)

27. A non-combustible aerosol provision device comprising:
a receptacle that defines a rod shaped consumable receiving space;
a fluid distribution column that upstands from a base of the receptacle and into the rod shaped consumable receiving space so that, in use, a rod shaped consumable may be placed over the fluid distribution column so that the fluid distribution column extends within the rod shaped consumable; and
a heater configured to heat the rod shaped consumable receiving space and comprising an inductor coil that extends around the receptacle, and
wherein the fluid distribution column is configured to be inductively heated by the inductor coil.

28. An aerosol provision system comprising the aerosol provision device of claim 1, and the article comprising the aerosol generating material.

29. An aerosol-provision system comprising
an article comprising aerosol-generating material; and
an aerosol provision device for heating the aerosol-generating material and comprising a receptacle defining a heating zone configured to receive at least a portion of the article comprising the aerosol-generating material; and
a heating element protruding in the heating zone and configured to heat the heating zone, wherein an air path is defined through the heating element.

30. The aerosol provision system of claim 29, wherein the article comprises a pre-formed bore configured to receive the heating element.
